(19) United States
(12) Patent Application Publication
(10) Pub. No.: US 2006/0271460 A1
(43) Pub. Date: Nov. 30, 2006

(54) Method and system to provide user created social networks in a distributed commerce system

(75) Inventor: Amjad Hanif, Santa Clara, CA (US)

Correspondence Address: SCHWEGMAN, LUNDBERG, WOESSNER & KLUTH/EBAY, P.O. BOX 2938, MINNEAPOLIS, MN, 55402, US

(73) Assignee: eBay Inc.

(21) Appl. No.: 11/238,310

(22) Filed: Sep. 29, 2005

Related U.S. Application Data
(60) Provisional application No. 60/685,969, filed on May 31, 2005.

(51) Int. Cl. G06Q 40/00

(52) U.S. Cl. 705/35; 705/40

(57) ABSTRACT

A system to identify a relationship network in a commerce system includes a first transaction identification module automatically to identify a first and a second party in a commerce network between whom a transaction has been at least partially successfully completed and to identify such parties as having a first degree relationship with one another. A network transaction identification module automatically identifies for the first party, at least one second degree party within the commerce network with whom the second party has at least partially successfully completed a transaction and automatically to identify such a party as having a second degree relationship with the first party. A network compiling module stores, in a memory network, data identifying the relationship network comprised of the first party and second party as having a first degree relationship and the at least one second degree party as having a second degree relationship with the first party.

### RELATED APPLICATION

This application claims priority under 35 U.S.C. 119(e) from U.S. Provisional Application Ser. No. 60/685,969 filed 31 May 2005, which application is incorporated herein by reference.

### FIELD

The present application relates generally to the technical field of commerce automation and, in one example embodiment, to methods and systems to provide buyers with functionality to create a social network of other buyers within a distributed commerce system.

### BACKGROUND

Electronic commerce that utilizes the Internet to sell goods and services to customers has been increasing in its scope and scale at increasing rates. One of the main limitations on this form of commerce is the lack of direct interaction between buyers and sellers that is present in most face-to-face transactions. Merchants and other sellers of goods and services have been hindered at times by an inability to identify trustworthy buyers who electronically request to purchase items while providing credit card or other payment information as well as a shipping address. Similarly, buyers may be hesitant to purchase items from a merchant who may only be found using an anonymous web site

To address these problems, trust relationships between buyers and sellers on commerce systems may be useful in overcoming the anonymity of users of the Internet. Typical users of commerce systems may purchase and sell many different items that are part of a series of non-related transactions. Each of these transactions allows for buyers and sellers to develop some level of trust with each other through the completion of any given transaction. Prior relationships of trust may be useful in creating a new trust relationship for a new transaction.

Similarly, buyers and sellers may communicate with each other using a commerce system in order to determine if completing a transaction is in each party's interest. This communication between users may allow relationships and levels of trust to develop as well. The creation of user defined relationships of trust may also be useful in identifying a level of trust between a buyer and seller for a new transaction.

These limitations of existing commerce systems limit the effectiveness of these systems to buyers and sellers. New mechanisms to connect interested buyers and sellers who use these commerce systems, and increase a level of trust between them, may address these limitations and thus increase on-line sales and corresponding profits for these sellers and commerce system operators.

### SUMMARY

The below described embodiments of the present invention are directed to methods and systems to provide user created social networks within a distributed commerce system.

In one aspect, a system to identify a relationship network in a commerce system includes:

a first transaction identification module automatically to identify a first and a second party in a commerce network between whom a transaction has been at least partially successfully completed and to identify such parties as having a first degree relationship with one another;

a network transaction identification module automatically to identify for the first party, at least one second degree party within the commerce network with whom the second party has at least partially successfully completed a transaction and automatically to identify such a party as having a second degree relationship with the first party; and

a network compiling module to store, in a memory network, data identifying the relationship network comprised of the first party and second party as having a first degree relationship and the at least one second degree party as having a second degree relationship with the first party.

In another aspect, a method of identifying a relationship network in a commerce system includes:

automatically identifying a first party and a second party in a commerce network between whom a transaction has been at least partially successfully completed;

automatically identifying the first party and the second party as having a first degree relationship with one another;

automatically identifying for the first party, at least one second degree party within the commerce network with whom the second party has at least partially successfully completed a transaction;

automatically identifying the at least one second degree party as having a second degree relationship with the first party; and

storing in a memory network data identifying the relationship network comprised of the first party and second party as having a first degree relationship and the at least one second degree party as having a second degree relationship with the first party.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a network diagram depicting a system having a client-server architecture for a commerce system having a desired item list in accordance with one example embodiment.

FIG. 2 is a detailed network diagram depicting a system having a client-server architecture in accordance with one example embodiment.

FIG. 3 is a block diagram illustrating multiple commerce system and payment applications in one example embodiment.

FIG. 4 is a high-level entity-relationship diagram in accordance with an example embodiment.

FIG. 5 is another network diagram depicting a system having a user created social network in accordance with one example embodiment.

FIG. 6 is an example embodiment of two interconnected social networks within a commerce system according to an example embodiment.

FIG. 7 is an example embodiment for a user search screen image for a social network according to an example embodiment.

FIG. 8 is an example embodiment for a basic search screen image containing a social network parameters according to an example embodiment.

FIG. 9 is an example embodiment for a user feedback screen image for containing social network data according to an example embodiment.

FIG. 10 is an example embodiment for a seller information screen image containing social network data according to an example embodiment.

FIG. 11 is an example embodiment for a user favorite profile screen image according to an example embodiment.

FIG. 12 is an example embodiment for a user search screen image for containing social network data related to user favorite profile data according to an example embodiment.

FIG. 13 is an example embodiment for a user favorite category screen image for containing social network data according to an example embodiment.

FIG. 14 is an example embodiment for a user search screen image for friends according to an example embodiment.

FIG. 15 is an example embodiment for a user friendship request screen image according to an example embodiment.

FIG. 16 is a flow diagram to associate a first user, a second user, and a third user based upon at least one shared criteria and/or association.

FIG. 17 is a block diagram illustrating a general programmable processing system having a social network module for use in programmable processing system in accordance with various embodiments of the present invention.

FIG. 18 is an exploded view of the social network module of FIG. 17, according to at least one embodiment.

FIG. 19 is a flow diagram showing a method of identifying a relationship network according to at least one embodiment.

### DETAILED DESCRIPTION

Methods and systems to provide user created social networks within a distributed computer system are described. In addition, methods and systems to provide buyers with a desired items list such as a gift registry list within a distributed computer system are described. In the following description, for purposes of explanation, numerous specific details are set forth in order to provide a thorough understanding of the present invention. It will be evident, however, to one skilled in the art that the present invention may be practiced without these specific details.

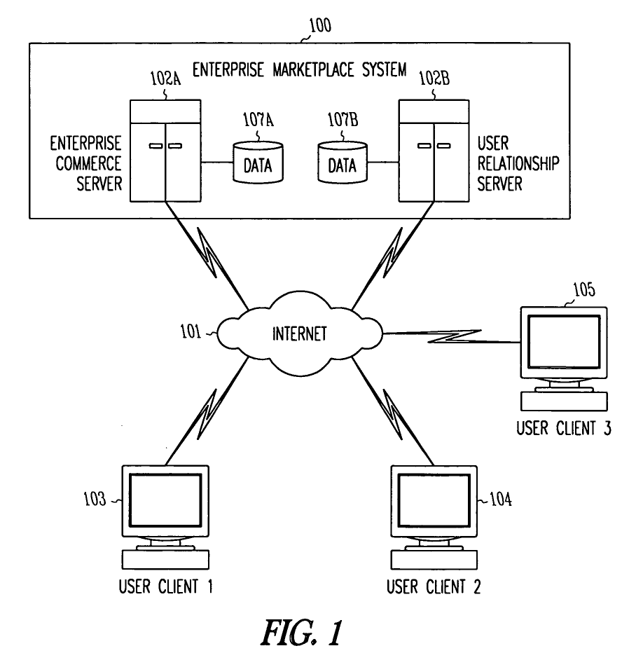

FIG. 1 is a network diagram depicting a system having a client-server architecture for a computer system having a desired item list in accordance with one example embodiment. The computer system 100 may be constructed from a plurality of network server devices 102A-102B connected to the Internet 101 for communication with a plurality of users 103-105. In an example embodiment, the system 100 may be a commerce system and items, (e.g., goods or services), for sale are listed on an enterprise commerce server 102A. In one embodiment, user of client 103 may post a listing for an item for sale to other users. User of client 104 may desire to acquire the item and may either search or browse the listed items on enterprise commerce server 102 A. When user of client 104 finds the item he or she desires, user of client 104 may initiate a transaction to purchase the item. The transaction may be part of an on-line action, a fixed-price transaction, or any other on-line transaction type. When the transaction is completed, payment for the item has been forwarded from user of client 104 to user of client 103 and the item has been shipped in response. In FIG. 1, data (e.g., a social network related table and a social network related content data) is stored within a database 107A and a database 107B connected to the enterprise commerce server 102A and the enterprise commerce server 102B respectively.

The completion of a transaction creates an implicit trust relationship between a user of client 103 and user of client 104. If the payment of the finds and shipment of the item occurs quickly and without a problem, both users may trust to enter into a new transaction when a new item of interest is listed. A similar level of trust, or lack thereof, may be created when problems and disputes arise as part of the transaction. User of client 104 may develop a level of trust from user of client 103 if the item arrives damaged or not in working order if the problem is resolved quickly and adequately. The failure to resolve this problem may harm any trust relationship between these users.

A similar relationship may be created between user of client 104 and user of client 105 if user of client 104 lists a different item for sale on the enterprise commerce server 102A. Once the second trust relationship has been created, a third trust relationship between user of client 103 and user of client 105 may be created through user of client 104. These potential trust relationships are discussed in more detail in reference to FIG. 5 below.

While the above example embodiment creates trust relationships between users because of completion of a transaction between the users, similar trust relationships may be defined by the users themselves.

These relationships between users, which are typically referred to as social networks of users, may be processed and maintained within a separate user relationship server 102B. This arrangement permits the social network data to be maintained within a social network database 103B. The social network data may be segregated from item listing and similar transaction data maintained within enterprise commerce server 102A in a transaction data database 102A. In alternate embodiments, these separate servers and related databases may be combined and partitioned into various arrangements without departing from the spirit and scope of the present invention as recited within the attached claims.

Platform Architecture

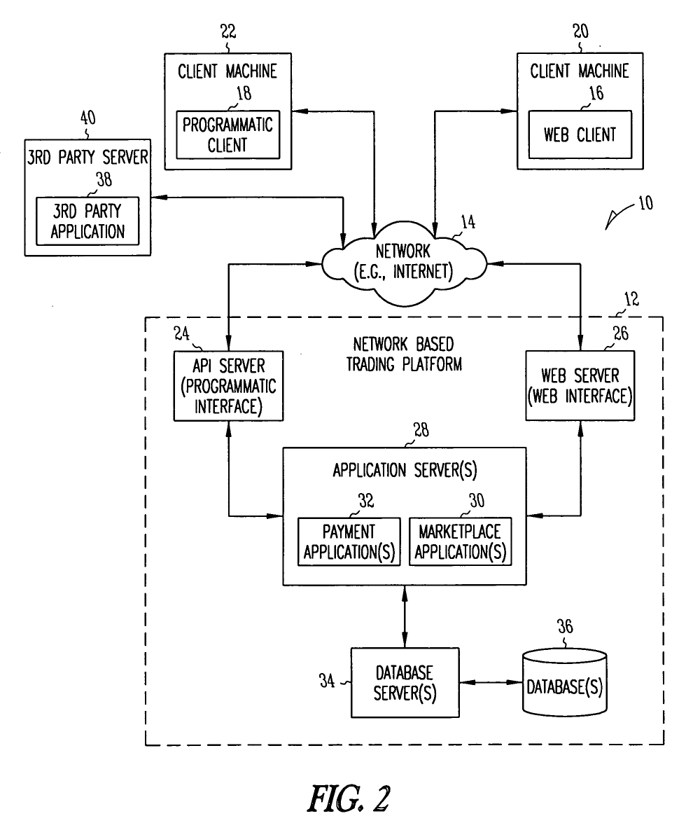

FIG. 2 is a network diagram depicting a system 10, according to one example embodiment, having a client-server architecture. A server platform, in the example form of commerce system 12, provides server-side functionality, via a network 14 (e.g., the Internet) to one or more clients. FIG. 2 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based commerce system 12, an Application Program Interface (API) server 24 and a web server 26 are coupled to, and provide programmatic and web interfaces respectively to, one or more application servers 28. The application servers 28 host one or more applications (e.g., commerce system applications 30 and payment applications 32.) The application servers 28 are, in turn, shown to be coupled to one or more databases servers 34 that facilitate access to one or more databases 36.

The commerce system applications 30 provide a number of commerce system functions and services to users that access the commerce system 12. The payment applications 32 likewise provide a number of payment services and functions to users. The payment applications 32 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the commerce system applications 30. While the commerce system and payment applications 30 and 32 are shown in FIG. 2 to both form part of the network-based commerce system 12, it will be appreciated that, in alternative embodiments of the present invention, the payment applications 32 may form part of a payment service that is separate and distinct from the commerce system 12.

Further, while the system 10 shown in FIG. 2 employs a client-server architecture, embodiments of the present invention are of course not limited to such an architecture, and could equally well find application in a distributed, or peer-to-peer, architecture system. The various commerce system and payment applications 30 and 32 could also be implemented as standalone software programs, which do not necessarily have networking capabilities.

The web client 16, it will be appreciated, accesses the various commerce system and payment applications 30 and 32 via the web interface supported by the web server 26. Similarly, the programmatic client 18 accesses the various services and functions provided by the commerce system and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings on the commerce system 12 in an off-line manner, and to perform batch-mode communications between the programmatic client 18 and the network-based commerce system 12.

FIG. 2 also illustrates a third party application 38, executing on a third party server machine 40, as having programmatic access to the network-based commerce system 12 via the programmatic interface provided by the API server 24. For example, the third party application 38 may, utilizing information retrieved from the network-based commerce system 12, support one or more features or functions on a website hosted by the third party. The third party website may, for example, provide one or more promotional, commerce system or payment functions that are supported by the relevant applications of the network-based commerce system 12.

Commerce System Applications

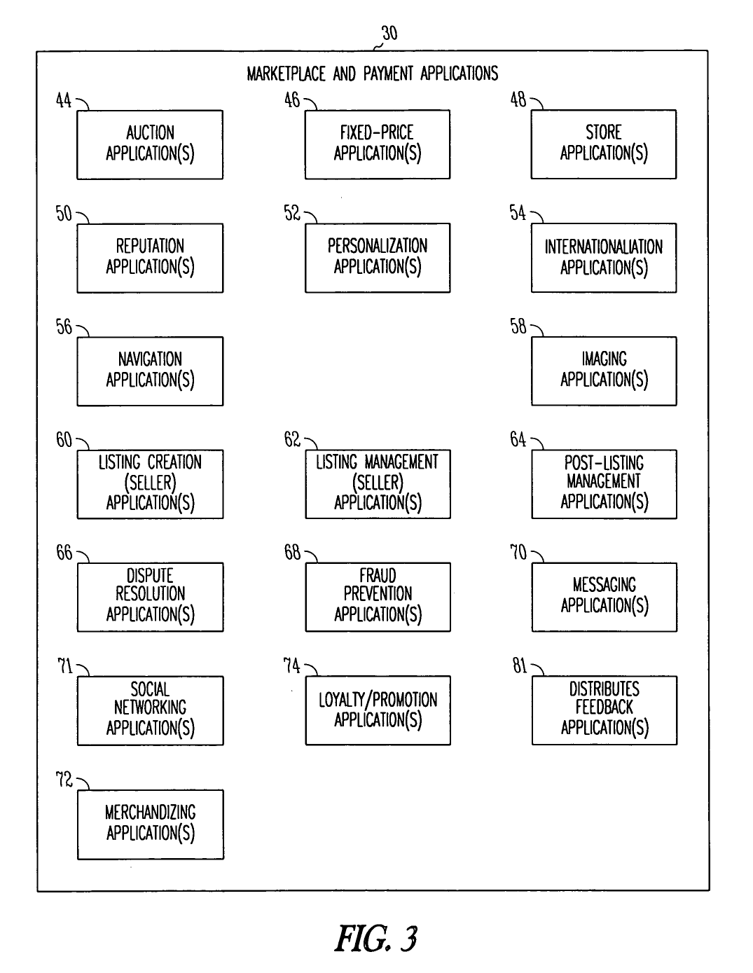

FIG. 3 is a block diagram illustrating multiple commerce system and payment applications 30 that, in one example embodiment, are provided as part of the network-based commerce system 12. The commerce system 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the commerce system applications 30 are shown to include one or more auction applications 44 which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based commerce system 12 to establish, build and maintain reputations, which may be made available and published to potential trading partners. Consider that where, for example, the network-based commerce system 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based commerce system 12 over time. Other potential trading partners may then reference such a reputation for the purposes of assessing credibility and trustworthiness.

Personalization applications 52 allow users of the commerce system 12 to personalize various aspects of their interactions with the commerce system 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the commerce system 12 and other parties.

In one embodiment, the network-based commerce system 12 may include a one or more internationalization applications 54 that support a number of marketplaces. Each marketplace may be customized, for example, for specific geographic regions. A version of the commerce system 12 may be customized for the United Kingdom, whereas another version of the commerce system 12 may be customized for the United States. Each of these versions may operate as an independent commerce system, or may be customized (or internationalized) presentations of a common underlying commerce system.

Navigation of the network based-commerce system 12 may be facilitated by one or more navigation applications 56. For example, a search application enables key word searches of listings published via the commerce system 12. A browse application allows users to browse various category, catalogue, or inventory data structures according to which listings may be classified within the commerce system 12. Various other navigation applications may be provided to supplement the search and browsing applications.

In order to make listings, available via the network-based commerce system 12, as visually informing and attractive as possible, the commerce system applications 30 may include one or more imaging applications 58 utilizing which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services that they wish to transact via the commerce system 12, and listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the commerce system 12.

Messaging applications 70 are responsible for the generation and delivery of messages to users of the network-based commerce system 12, such messages for example advising users regarding the status of listings at the commerce system 12 (e.g., providing “outbid” notices to bidders during an auction process or to provide promotional and merchandising information to users).

Merchandising applications 72 support various merchandising functions that are made available to sellers to enable sellers to increase sales via the commerce system 12. The merchandising applications 80 also operate the various merchandising features that may be invoked by sellers, and may monitor and track the success of merchandising strategies employed by sellers.

Social networking applications 71 support the creation, maintenance, searching and display of social network data between users, their listed items, their user defined interests and profiles, and other related data. These applications permit the buyers and sellers to define and utilize social networks to increase trust relationships between users prior to initiating transactions for listed items.

Distributed feedback applications 81 support the creation, the maintenance, and the searching of feedback data records within a distributed feedback data database. Distributed feedback applications 81 perform all of the functions disclosed herein to permit these feedback data records to be created, stored within the database, and retrieved in response to search queries.

The network-based commerce system 12 itself, or one or more parties that transact via the commerce system 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

Data Structures

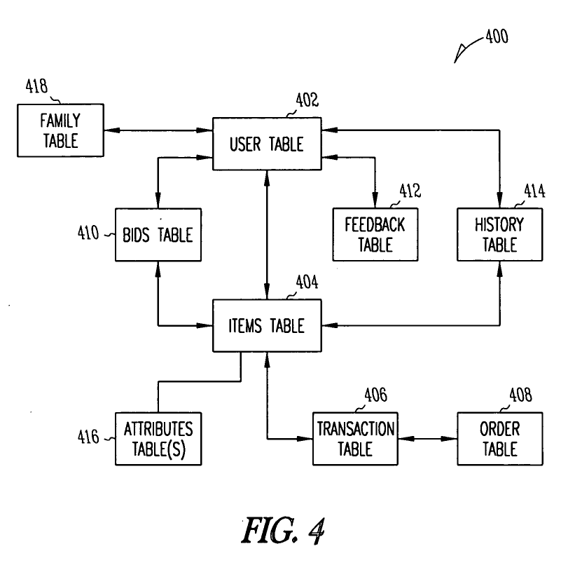

FIG. 4 is a high-level entity-relationship diagram, illustrating various tables 90 that may be maintained within the databases 36, and that are utilized by and support the commerce system and payment applications 30 and 32. A user table 92 contains a record for each registered user of the network-based commerce system 12, and may include identifier, address and financial instrument information pertaining to each such registered user. In one embodiment, the user table 92 contains information about each user connected to each other through a social interaction application (e.g., the social interaction application(s) 71 of FIG. 3). A user may, it will be appreciated, operate as a seller, a buyer, or both, within the network-based commerce system 12. In one example embodiment, a buyer may be a user that has accumulated value (e.g., commercial or proprietary currency), and is then able to exchange the accumulated value for items that are offered for sale by the network-based commerce system 12.

The tables 90 also include an items table 94 in which are maintained item records for goods and services that are available to be, or have been, transacted via the commerce system 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based commerce system 12 in connection with an auction-format listing supported by an auction application 44. A feedback table 102 is utilized by one or more reputation applications 50, in one example embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller. Family table 110 and user currency table 108 used to support related items and multiple currencies in transactions.

FIG. 5 is another network diagram depicting a system having a user created social network in accordance with one example embodiment. User of client 103 creates a first degree trust relationship 501 with user of client 104 through a transaction and user definition. User of client 104 may also create a first degree trust relationship 502 with user of client 105 in a similar manner. A potential second degree trust relationship 510 between user of client 103 and user of client 105 may be inferred by either of these users through their separate trust relationships 501-502 with user of client 104. This potential trust relationship 510 is defined as possessing 2 degrees of trust as the relationship 510 involves a sequence of two users. Similar potential trust relationships between additional user of clients results in relationships possessing higher degrees of trust.

These social networks of trust relationships may use transaction trust relationships, user defined trust relationships, and both types of trust relationships. When user 103 discovers the potential trust relationship 510 through user of client 104, user of client 103 may examine the nature of the individual trust relationships 501-502 that have combined to create the potential trust relationship 510 to determine how much trust may be inferred by these separate relationships. A user may place a higher value on either type of trust relationship based upon his or her own preferences when evaluating potential trust relationship 510.

In order to identify the network, a network identity system is associated or integrated with the enterprise commerce system 100. The network identity system includes a first transaction identification module to identify a first party in the example form of the user of client 103 and a second party in the example form of the user of client 104 in the commerce network. As has previously been explained, the first and second parties have at least partially successfully completed a transaction. The first transaction identification module identifies the parties as having a first degree relationship with one another.

Also included in the system is a network transaction identification module to identify for the first party, at least one second degree party within the commerce network with whom the second party 104 has at least partially successfully completed a transaction. In the illustrated embodiment this is the user of client 105. The network transaction identification module then identifies user of client 105 as having a second degree relationship with the user of client 103.

The system also includes a network compiling module to store in a memory network data identifying a network comprised of the first party user of client 103, second party user of client 104 as having a first degree relationship and user of client 105 as having a second degree relationship with the first party and a first degree relationship with the user of client 104.

It will be appreciated that if the first party user of client 103 has transacted with a user of a fourth client (not shown), the user of the fourth client will have a second degree trust relationship with the second party user of client 104.

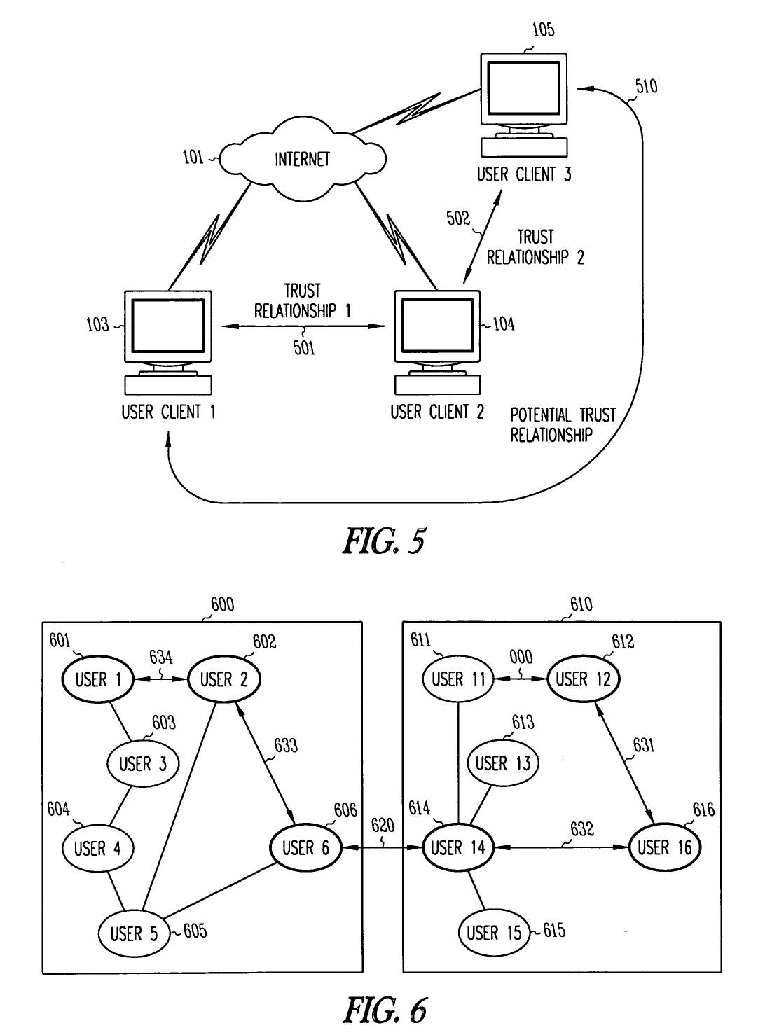

FIG. 6 is an example embodiment of two interconnected social networks within a computer system, according to an example embodiment; Social networks formed from sets of inter-related trust relationships may take on any number of forms. Social network 600 and social network 610 both contain 6 interconnected users of clients 601-660 and 611-616. Within each social network 600, 610, individual trust relationships are indicated using the interconnecting lines between user of clients.

Social network 600 contains a set of user of clients 601-606 that each contain at least two interconnecting trust relationships with other user of clients in the social network. User of client 602 and user of client 605 both contain interconnecting trust relationships with 3 separate user of clients. Any user of client may create a trust relationship with another user of client as described herein.

Similarly, social network 610 contains a set of user of clients 611-616 that each contain one such trust relationship. Only user of client 614 and user of client 616 contain multiple trust relationships. If a trust relationship 620 is created between user of client 614 and user of client 606, all of the user of clients in social network 600 and social network 610 will be interconnected into a single network. For example, user of client 612 may infer a trust relationship with user of client 601 through the sequence of trust relationships 631, 632, 620, 633, 634. This represents a degree 5 trust relationship. From such interconnecting trust relationships, any user may infer a potential trust relationship with any other user of client in either social network.

In order to identify the network within the commerce system, the system includes a network criteria module to receive a maximum number of degrees input as a network constraint. This network constraint will then be used to identify for a party, other parties with a degree of relationship less than or equal to the maximum number of degrees.

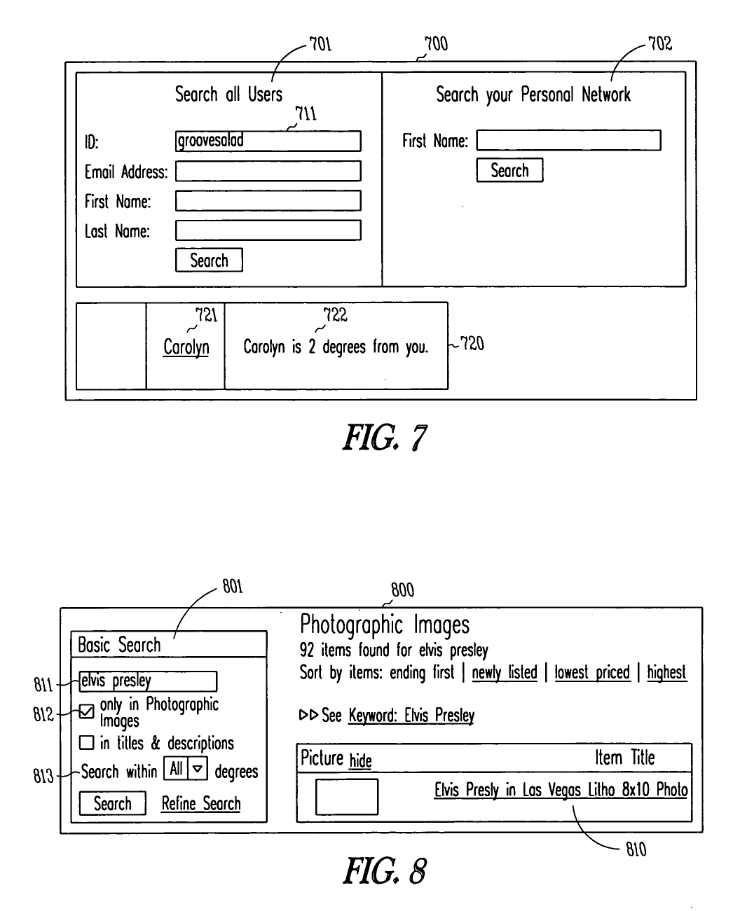

Once a social network has been created for a user of the computer system 100, the user may search using a search module for information related to, or associated with, other users. For example, a user may search for items by searching for items listed by other users within the social network. FIG. 7 is an example embodiment for a user search screen image 700 for a social network, according to an example embodiment. Within user search screen image 700, a search may be performed on either all users in screen frame 701 or on only user defined friends. Friends are defined as user defined trust relationships.

When a user searches for a particular user ID 711, a result for a corresponding user 720 may be provided. This search result 720 may contain identifying information such as a name 721 and the degree of the relationship 722 between the searching user and the located user. Because items listed on the system 100 typically identify a user ID for the seller, user search screen image 700 may provide potential buyers to determine if a potential trust relationship exists with the seller before a transaction is initiated. Additional screen images may provide additional information regarding the individual trust relationships that make up the potential trust relationship.

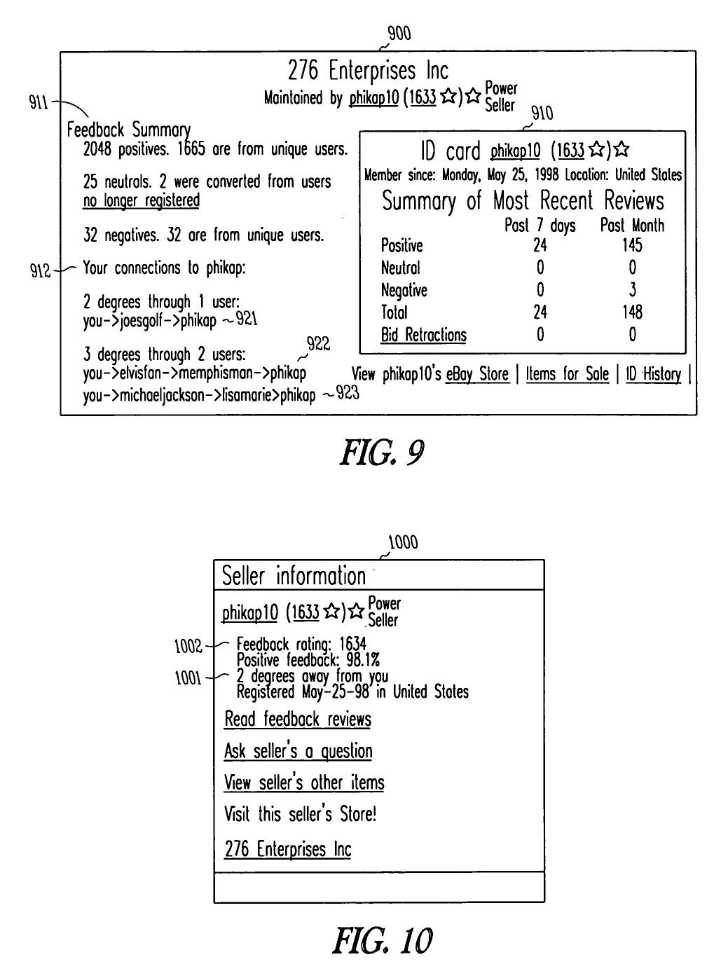

FIG. 8 is an example embodiment for a basic search screen image containing social network parameters according to an example embodiment. In this example embodiment for a basic search of items 801, listings containing references to “Elvis Presley” 811 within a photographic image category of items 812 is shown. The search input may utilize any number of identifying characteristics, such as keywords, item category, existence of an item photograph, and other available identifying characteristics that the basic search 801 may support. Typically, items listed on enterprise commerce system 100 contain a number of such identifying characteristics to permit buyers to more readily find items of interest.

When a search is performed, one or more search results 810 may be returned that meet any specified search criteria. Users may specify 812 that the search return results from only sellers who possess a potential trust relationship contained within the user's social network. The search may specify that all listings be searched when the basic search 801 specifies that all degrees of trust are desired 802. If a user wants to limit the search results 810 to sellers having a potential trust relationship possessing a specified degree of trust (e.g., 5 degrees shown with reference to FIG. 6 above), such a search limitation may be specified. As such, buyers may locate items in which the seller user may possess a degree of trust that any initiated transaction may occur smoothly.

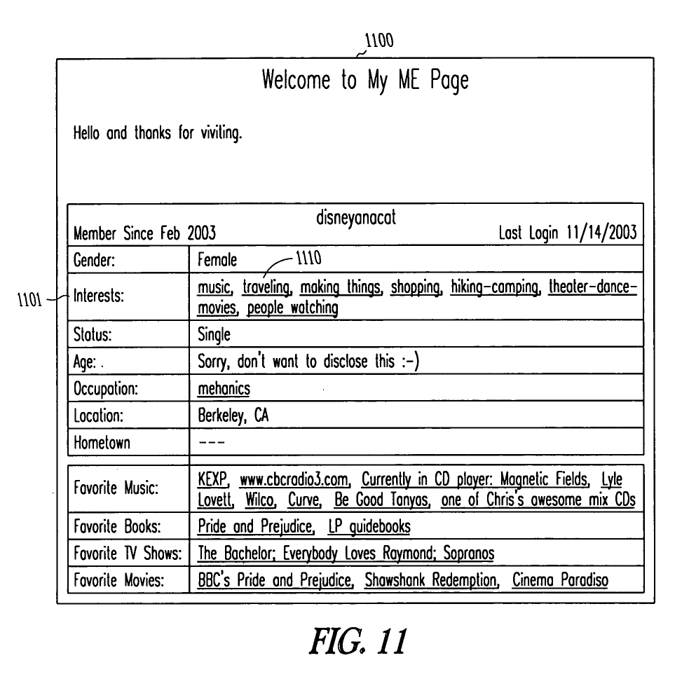

FIG. 9 is an example embodiment for a user feedback screen image for containing social network data, according to an example embodiment. Social network data may also be presented when users of the system 100 retrieve seller feedback data for a particular user. The system 100 may maintain positive and negative feedback from other users of the system 100 after a transaction has been completed. This feedback data for each user of enterprise commerce system system 100 may be presented to other users when examining a listing for an item listed by the user. This feedback data 900 may contain feedback results 910 and a corresponding summary of historical results 911. If potential trust relationships exist with the seller, descriptions of these potential trust relationships may be presented 912. In this example, one potential trust relationship 921 having 2 degrees of trust is shown, as well as two potential trust relationships 922-923 having 3 degrees of trust. Any number of trust relationships and trust relationships having any specified degrees of trust may be provided to a user. Using this data, a buyer may determine whether a transaction with this seller may be trusted.

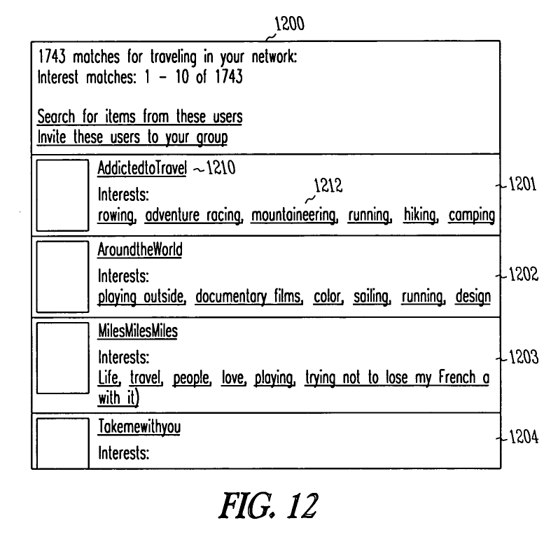

FIG. 10 is an example embodiment for a seller information screen image containing social network data, according to an example embodiment. In this example, a brief summary of a seller 1000 is presented that presents both a summary of social network data 1001 as well as seller feedback data 1002. This summary data 1000 may be part of a separate user screen or may be included within a listing for an item on enterprise commerce system 100. By activating a control, such as hyperlink within the brief summary 1000, a user may obtain additional information such as the data presented in FIG. 9 above.

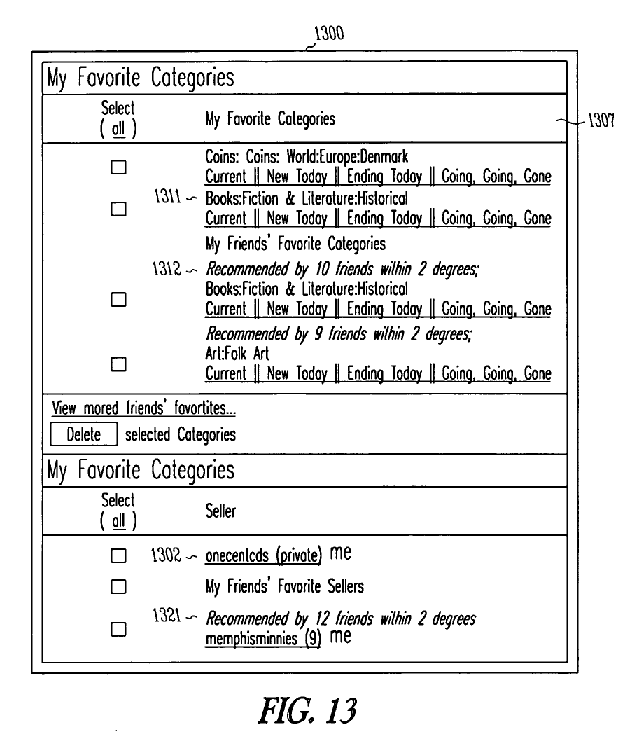

In order for users of the system 100 to identify other users who may be potential friends on the system, the system 100 may permit each user to define a user profile 1100. FIG. 11 is an example embodiment for a user favorite profile screen image, according to an example embodiment. The profile 1100 may contain a set of information categories that permit a user to provide a profile that defines his or her interests, location, and similar identifying information. In this example, these categories may include gender, interests, marital status, age, occupation, location, hometown, favorite music, favorite books, favorite TV shows, and favorite movies. Any other such categories may be used.

Once such category may include interests 1001 that a user may specify using any number of keywords. Each of these keywords may be used to identify other users with a similar interest. A search of users having the specified interest keyword, for example traveling 1110, may be performed. As noted above with reference to FIG. 8, such a search may be limited to all users or only users having a degree of trust less than a specified value. In this example, such a search may be performed by activating a control 1110.

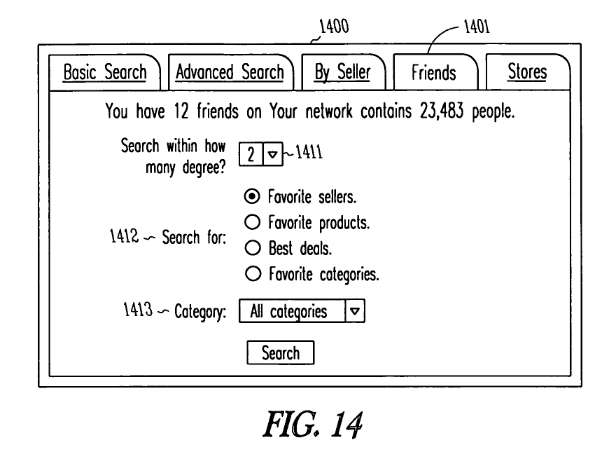

FIG. 12 is an example embodiment for a user search screen image for containing social network data related to user favorite profile data, according to an example embodiment. This user search screen image 1200 corresponds to the activation of control 1110, such as a hyperlink, in FIG. 11. The search results 1200 contain a list of users having within their respective interests the keyword “traveling”. Each user identified within the list contains a set of identifying information. For example, a first listed user 1201 is shown with a user ID 1211 and a list of the users interests 1212. Similar entries are shown for other users as well 1202-1204.

This example provides a search for users containing a single keyword in interest category of a user profile. More complex searches for users containing matches in a plurality of interest categories 1101 on user profiles 1100 may also be performed. Such searches may identify other users of the system 100 having common interests with any user.

Using these search results, users may attempt to develop user defined trust relationships, e.g., friends, with other users. Users may communicate with other users to determine if such a friend-type trust relationship may be desired. By creating such trust relationships, meaningful social networks may be created. Such social networks may be of assistance to users in locating desired items on enterprise commerce system 100, as well as permitting increased trust in any potential transaction. For example, a user may be interested in acquiring an item related to the “traveling” interest. The user may contact other users in their social network seeking the item, information on locating the item, and information on how such an item may be found. From this communication, the user may find a listing for such an item, and a transaction for the item may be initiated. If a listing for an item is not found, this communication may prompt a contacted user to create such a listing for the item to satisfy the potential buyer's interest in the item. Further, the searching user may then also create a “wanted” listing, or a “buyer request” listing, for the sought item. In either case, the creation and use of these social networks may assist in the creation of a transaction for a listed item.

FIG. 13 is an example embodiment for a user favorite category screen image 1300 including social network data, according to an example embodiment. Users may also identify listed items on the system 100 by specifying favorite categories and favorite sellers/stores. Users may identify these favorite categories within their respective user profiles while using system 100.

When a user wishes to browse for items, the user may begin by looking within his or her own favorite categories. The user favorite category screen image 1300 contains a listing of item categories 1301 that the user identified as his or her favorites 1311. This listing of item categories 1301 may also list categories of friends 1312 as defined within the user's social network. For each of these categories, the user may view various subsets of the available listings, such as new today, ending today, and going, going, gone items. Similarly all open listings may be viewed as current listings.

Users may specify favorite sellers 1302 from prior transactions and searches for items. As above, this listing may also provide reference to favorite sellers of friends 1321 to introduce a user to other potential sellers who may list items of interest. As such, users may be assisted in locating items of interest through the favorite sellers of friends.

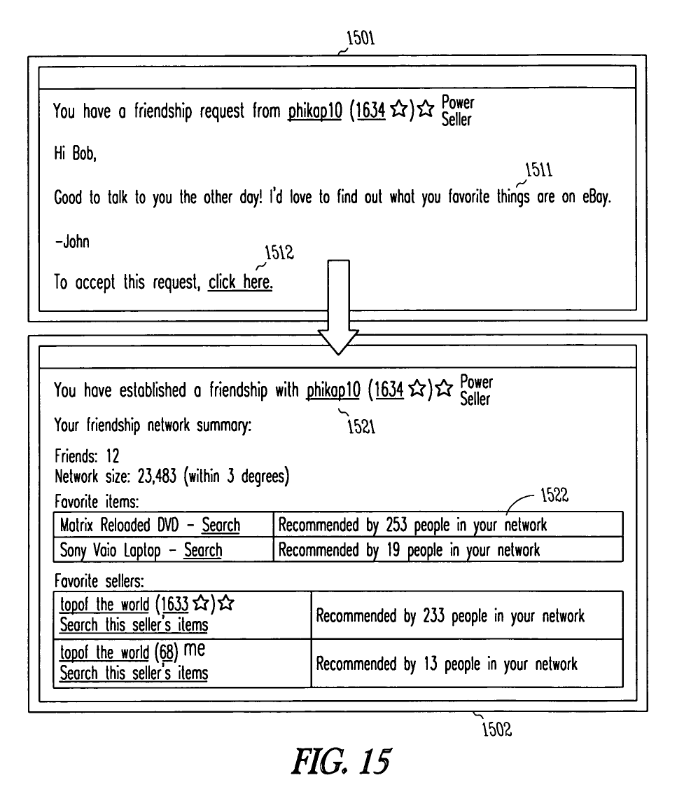

FIG. 14 is an example embodiment for a user search screen image for friends according to an example embodiment. Users search for listed items using a search screen 1400 that contains a set of different search criteria. These sets of search criteria may include a basic search, an advance search, a “by seller” search, a friends search, and a stores search. In this example embodiment, a friends search is performed when a friends tab 1401 on the search screen 1400 is active. Other search criteria may be selected by activating other tabs corresponding to the other criteria.

When performing a friends search, users specify a desired degree for the degree of trust between identified friends 1411. The search may specify the type of search to be performed 1412. Users may limit the search to only a subset of all possible categories 1413 as well. When the search is performed, search results similar to the results described above in reference to FIG. 13 may be produced.

As discussed above in reference to FIG. 1 and FIG. 5, trust relationships may be created in different ways. Trust relationships may be created using prior transactions between users. These trust relationships may be created automatically when a transaction is completed. If users to the transaction provide feedback on the transaction, the trust relationship may be defined. Thus, users may specify that only positive feedback be used to define a trust relationship when social networks are created using transaction relationships.

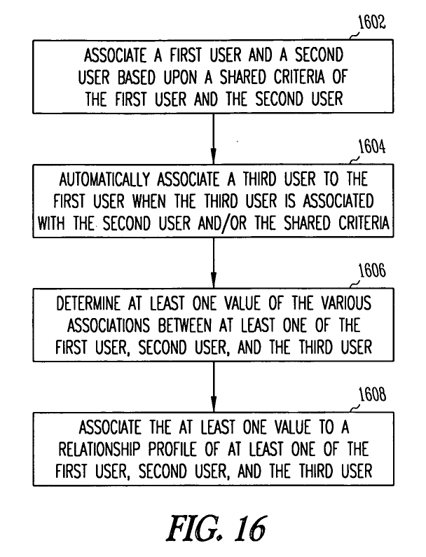

Users may also be user defined as relationships such as when users create friends on the system 100. FIG. 15 is an example embodiment for a user friendship request screen image according to an example embodiment. The process of adding a user to a list of friends requires at least two steps to occur.

First, one of the two users to the friends-type trust relationship may propose, or invite, the other user to be part of the friends-type trust relationship. This invitation 1501 may be part of an invitation message sent from a first user to second user. This invitation provides an opportunity for the first user to provide a message 1511 that is personal to these two users. If the second user wants to accept the invitation, the second user activates an input control 1512 within the invitation message 1501.

Once the friends-type trust relationship is created, a successful friend creation message 1502 may be created and returned to the first user. This message 1502 identifies the new friend 1521, as well as other user information such as favorite items 1522 and favorite sellers 1523. Other information about the new friends may also be provided using the new friend's user profile as described above in reference to FIG. 11.

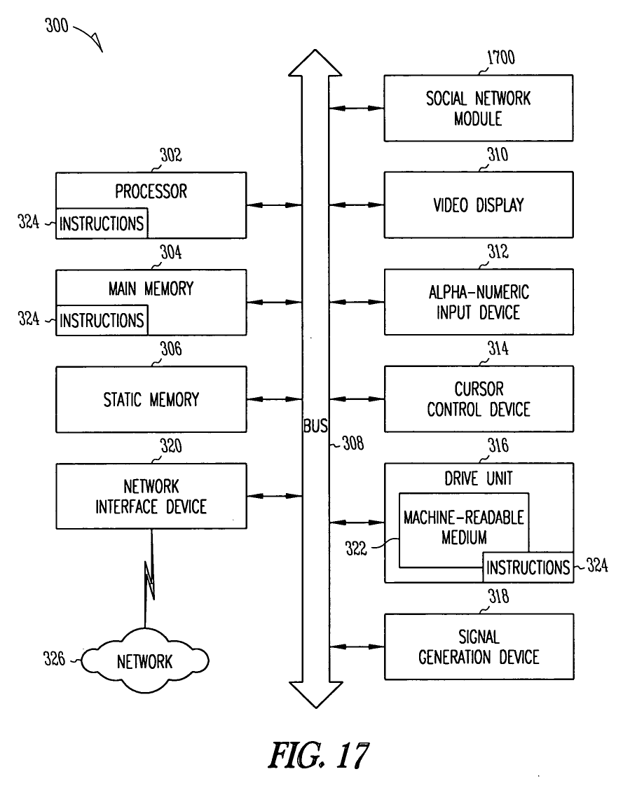

FIG. 16 is a flow diagram to associate a first user, a second user, and a third user based upon at least one shared criteria and/or association. In operation 1602, a first user is associated to a second user based upon a shared criteria (e.g., the shared criteria may be a common transaction on the network based trading platform 12 of FIG. 2, and/or an attribute such as geographical location, purchase volume, category of purchase, and/or trading expertise). In operation 1604, a third user is automatically (e.g., through a logic such as the system 100) associated to the first user when the third user is associated with the second user and/or the shared criteria. In operation 1606, at least one value (e.g., a ranking value as previously described in FIG. 5 and 6) is determined of the various associations between at least one of the first user, the second user, and the third user (e.g., by allowing a particular user to elect what level of confidence/trust he has with each one of his social relationships, as previously described in FIG. 5 and 6). In operation 1608, at least one value is associated with a relationship profile of at least one of the first user, the second user, and the third user (e.g., based upon a user selected input that ranks each of the relationships associated with the particular user).

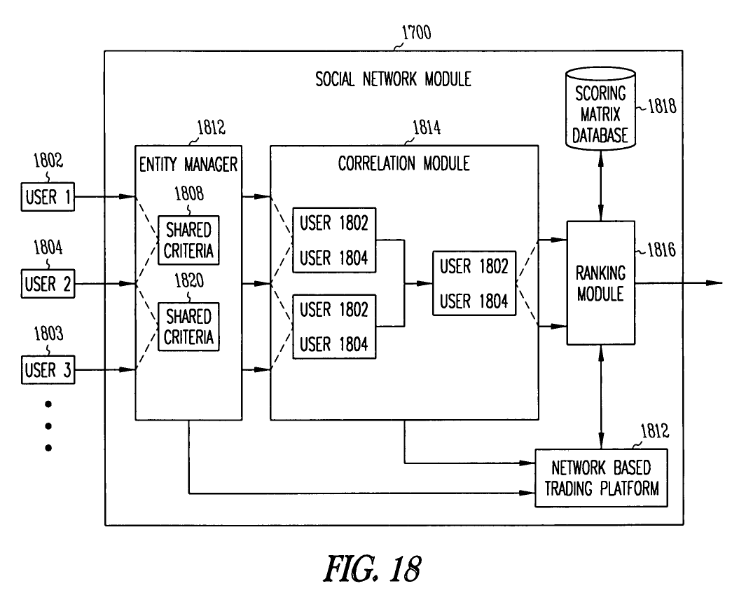

FIG. 17 shows a diagrammatic representation of machine in the example form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

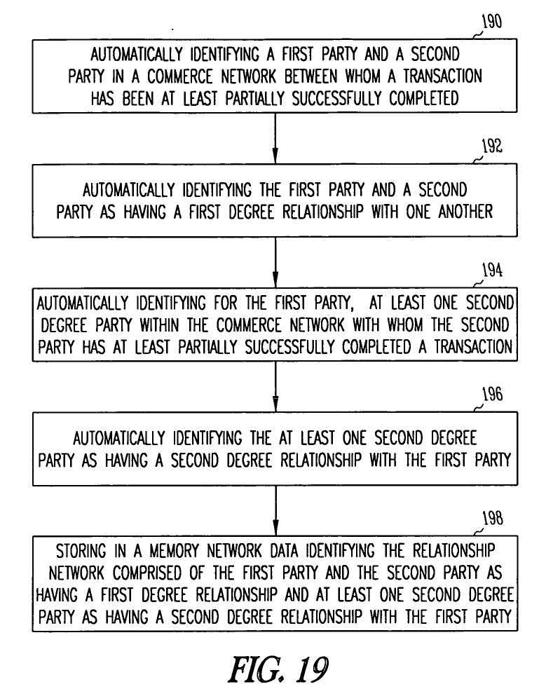

FIG. 18 illustrates an example social network module 1700 (e.g., a software and/or hardware embodiment). The social network module 1700 may perform any of the operations as previously described in FIG. 1-FIG. 17 in one embodiment. In alternate embodiments, the social network module 1700 may be located in the enterprise commerce system 100 of FIG. 1.

An exploded view of the social network module 1700 is illustrated in FIG. 18. A first user 1802 and a second user 1804 enter the social networking module 1700 through an entity manager 1812, in the embodiment of FIG. 18. The first user 1802 and the second user 1804 may each have associated with them a shared criteria 1808 (e.g., the shared criteria may be a common transaction on the network based trading platform 12 of FIG. 2, and/or an attribute such as geographical location, purchase volume, category of purchase, and/or trading expertise). Similarly, a third user 1806 and the second user 1804 each have associated with them a different shared criterion 1810.

The entity manger 1812 may analyze information associated with the various users (e.g., the first user 1802, the second user 1804, and the third user 1806) by identifying shared criteria of the various users.

Next, a correlation module 1814 may determine what associations can be made between the various users based on the shared criteria. For example, illustrated in the correlation module 1814 of FIG. 18, the first user 1802 and the second user 1804 are associated based on the shared criteria 1808. Similarly, the second user 1804 and the third user 1806 are associated with each other. The correlation module 1814 may determine a correlation between the first user 1802 and the third user 1806 based on the shared association with the second user 1804. In alternate embodiments, the correlation module 1814 may make a determination based upon a shared criteria rather than a shared user. As a result, the correlation module 1814 forms an association of the first user 1802 and the third user 1806.

Next, the ranking module 1816 receives the correlated relationships from the correlation module 1814. The ranking module 1816 may reference a scoring matrix database 1818 to determine a strength of a relationship of the first user 1802 and the third user 1806 (e.g., a user may elect how strong he/she believes his/her relationship is with a particular user as described in FIG. 5, 6, and 16, or based on feedback ratings that have been provided by the users regarding each other). It should be noted that the entity manager 1812, the correlation module 1814, and the ranking module 1816 each may be associated with the system to determine and receive information criteria (e.g., shared criteria such as items previously purchased, listed, etc.). Similarly, social relationship data correlated through the entity manager 1812, the correlation manager 1814, and the ranking module 1816 may be transferred back to the system 100 for utilization during decision making functions (e.g., deciding what products to buy, list, recommend, etc.) of various aspects of the network based trading platform 12.

Referring back to FIG. 17, the disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media. The software 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to provide social networks have been described. In addition, a feedback data within a distributed feedback database of a system have been described. Although the present invention has been described with reference to specific example embodiments, it will be evident that various modifications and changes may be made to these embodiments without departing from the broader spirit and scope of the invention.

Although the present embodiments has been described with reference to specific example embodiments, it will be evident that various modifications and changes may be made to these embodiments without departing from the broader spirit and scope of the invention. For example, the various modules described herein may be preformed and created using hardware circuitry (e.g., CMOS based logic circuitry) as well as in software.

For example, the social network module 1700, the entity manager 1812, the correlation manager 1814, the ranking module 1816, and the scoring matrix database 1818 may be embodied using transistors, logic gates, and electrical circuits (e.g., application specific integrated ASIC circuitry) using social network circuit, the entity circuit, a correlation manager circuit, a ranking circuit, and the scoring matrix database circuit. In addition, it will be appreciated that the various operations, processes, and methods disclosed herein may be embodied in a machine-readable medium and/or a machine accessible medium compatible with a data processing system (e.g., a computer system). Accordingly, the specification and drawings are to be regarded in an illustrative rather than a restrictive sense.

FIG. 19 is a flow diagram showing a method of identifying a relationship network according to embodiment.

The method includes automatically identifying 190 a first party and a second party in a commerce network between whom a transaction has been at least partially successfully completed.

Automatically identifying 192 the first party and the second party as having a first degree relationship with one another.

For the first party, at least one second degree party is automatically identified 194 within the commerce network with whom the second party has at least partially successfully completed a transaction.

At least one second degree party is automatically identified 196 as having a second degree relationship with the first party.

Data is stored 198 in a memory network identifying the relationship network comprised of the first party and second party as having a first degree relationship and the at least one second degree party as having a second degree relationship with the first party.

What is claimed is:

1. A system to identify a relationship network in a commerce system, the system including:
a first transaction identification module automatically to identify a first and a second party in a commerce network between whom a transaction has been at least partially successfully completed and to identify such parties as having a first degree relationship with one another;
a network transaction identification module automatically to identify for the first party, at least one second degree party within the commerce network with whom the second party has at least partially successfully completed a transaction and automatically to identify such a party as having a second degree relationship with the first party; and
a network compiling module to store, in a memory network, data identifying the relationship network comprised of the first party and second party as having a first degree relationship and the at least one second degree party as having a second degree relationship with the first party.

2. A system according to claim 1, wherein the network transaction identification module is to identify for the second party, at least one second degree party within the commerce network with whom the first party has at least partially successfully completed a transaction and to identify the at least one second degree party as having a second degree relationship with the second party, and wherein the network compiling module is to store, in the memory, a network data identifying the relationship network as additionally comprising of at least one second degree party having a second degree relationship with the second party.

3. A system according to claim 2, wherein the network transaction identification module further is to identify for each of the first party's at least one second degree party, at least one third degree party who has at least partially successfully completed a transaction with the first party's at least one second degree party, and is to identify a that the first party has a third degree relationship with the at least one third degree party, and wherein the network compiling module is to store, in the memory, network data identifying the relationship network as additionally comprising of at least one third degree party having a third degree relationship with the first party.

4. A system according to claim 3, wherein the network transaction identification module further is to identify for each of the second party's at least one second degree party, at least one third degree party who has at least partially successfully completed a transaction with the second party's at least one second degree party and is to identify that the second party has a third degree relationship with the at least one third degree party, and wherein the network compiling module is to store in the memory network data identifying the relationship network as additionally comprising of at least one third degree party having a third degree relationship with the second party.

5. A system according to claim 1, further including a network criteria module to receive a maximum number of degrees input as a network constraint and wherein the network transaction identification module further is to identify for at least one of the first party and second party other parties with a degree of relationship less than or equal to the maximum number of degrees.

6. A system according to claim 1, further including a search module to receive other search criteria input from the first party or second party, and to search the relationship network using the search criteria.

7. A method of identifying a relationship network in a commerce system, the method including:
automatically identifying a first party and a second party in a commerce network between whom a transaction has been at least partially successfully completed;
automatically identifying the first party and the second party as having a first degree relationship with one another;
automatically identifying for the first party, at least one second degree party within the commerce network with whom the second party has at least partially successfully completed a transaction;
automatically identifying the at least one second degree party as having a second degree relationship with the first party; and
storing in a memory network data identifying the relationship network comprised of the first party and second party as having a first degree relationship and the at least one second degree party as having a second degree relationship with the first party.

8. A method according to claim 7, further including identifying for the second party, at least one second degree party within the commerce network with whom the first party has at least partially successfully completed a transaction and identifying the at least one second degree party as having a second degree relationship with the second party, and storing in the memory network data identifying the relationship network as additionally comprising of at least one second degree party having a second degree relationship with the second party.

9. A method according to claim 8 further including identifying for each of the first party's at least one second degree party, at least one third degree party who has at least partially successfully completed a transaction with the first party's at least one second degree party and identifying that the first party has a third degree relationship with the at least one third degree party, and storing in the memory network data identifying the relationship network as additionally comprising of at least one third degree party having a third degree relationship with the first party.

10. A method according to claim 9 further including identifying for each of the second party's at least one second degree party, at least one third degree party who has at least partially successfully completed a transaction with the second party's at least one second degree party and identifying that the second party has a third degree relationship with the at least one third degree party, and storing in the memory network data identifying the relationship network as additionally comprising of at least one third degree party having a third degree relationship with the second party.

11. A method according to claim 7 further including receiving a maximum number of degrees input as a network constraint and identifying for at least one of the first party and second party other parties with a degree of relationship less than or equal to the maximum number of degrees.

12. A method according to claim 7 further including receiving other search criteria input from the first party or second party and searching the relationship network using the search criteria.

13. A machine-readable medium comprising instructions, which when executed by a machine, cause the machine to perform a method of identifying a relationship network in a commerce system, the method including:
automatically identifying a first party and a second party in a commerce network between whom a transaction has been at least partially successfully completed;
automatically identifying the first party and the second party as having a first degree relationship with one another;
automatically identifying for the first party, at least one second degree party within the commerce network with whom the second party has at least partially successfully completed a transaction;
automatically identifying the at least one second degree party as having a second degree relationship with the first party; and
storing in a memory network data identifying the relationship network comprised of the first party and second party as having a first degree relationship and the at least one second degree party as having a second degree relationship with the first party.
